(19) United States
(12) Patent Application Publication
(10) Pub. No.: US 2014/0199136 A1
(43) Pub. Date: Jul. 17, 2014

(54) GLUE APPLICATION UNIT FOR PERFECT BINDING MACHINE

(71) Applicants: Hirohito Nakanishi, Takashima-shi (JP); Kou Ohuchiyama, Takashima-shi (JP); Takehito Yokogi, Takashima-shi (JP); Akira Onodera, Takashima-shi (JP)

(72) Inventors: Hirohito Nakanishi, Takashima-shi (JP); Kou Ohuchiyama, Takashima-shi (JP); Takehito Yokogi, Takashima-shi (JP); Akira Onodera, Takashima-shi (JP)

(73) Assignee: HORIZON INTERNATIONAL INC., Takashima-shi, Shiga (JP)

(21) Appl. No.: 14/233,605

(22) PCT Filed: Sep. 2, 2011
(86) PCT No.: PCT/JP2011/070001

§ 371 Date: Jan. 17, 2014

(51) Int. Cl. B42C 9/00

(52) U.S. Cl. CPC B42C 9/00
USPC 412/37

(57) ABSTRACT

The gluing unit is provided with a sideways glue-applying member which can engage with throat regions (s) on both sides of a spine (r) of a book body (P), and the lateral glue-applying member is provided with a pair of scrapers (7, 7). Each scraper of the pair of scrapers is configured from an elastic rod-shaped main body (7a) and a scraping part (7b). The rear ends of the main bodies (7a) are fixed to a frame (1) on both sides outside the path. The scraping parts (7b) are positioned further downstream than the top surface of a glue application roller (3) in the path. While a portion of the book body that projects downward passes between the pair of scrapers, the scraping parts engage with the throat region on both sides of the spine of the book body.

### TECHNICAL FIELD

The present invention relates to a glue application unit for a perfect binding machine.

### BACKGROUND ART

One of perfect binding machines which are well-known in the prior art is provided with a series of binding units and at least one clamp unit serially moving through the binding units, wherein a book block is held between a pair of clamp plates of the clamp unit and then, while the book block is conveyed by the clamp unit along the series of binding units, the perfect binding is performed (cf. for example, Patent Document 1).

FIG. 6 is a plan view schematically showing the configuration of the conventional perfect binding machine. Referring to FIG. 6, the perfect binding machine comprises a series of binding units (a milling unit B, a glue application unit C and a cover attachment unit D) which are arranged along a conveying path F, a single clamp unit 31 arranged for reciprocal movement along the conveying path F, and a drive mechanism (not shown) moving the clamp unit 31 along the conveying path F. The clamp unit 31 has stationary and movable clamp plates 31a, 31b, and a motor M1 for moving the movable clamp plate 31b in directions toward and away from the stationary clamp plate 31a.

When the perfect binding is started, at a book block insertion position A, a book block (not shown) is inserted between the pair of clamp plates 31a, 31b of the clamp unit 31 and placed on an alignment plate 31c with its back face downwardly facing. Then the book block is held between the clamp plates 31a, 31b in such a way that back margins, which are located at both sides of the back face of the book block, protrudes downwardly from the clamp unit 31, and then conveyed by the clamp unit 31 toward the milling unit B along the conveying path F.

The milling unit B has a milling cutter 32a, a pair of stationary and movable guide plates 32b, 32c, and a motor M2 for moving the movable guide plates 32c in directions toward and away from the stationary guide plate 32b. While the book block moves through the milling cutter 32a, both sides of the book block protruding between the pair of clamp plates 31a, 31b passes between the pair of guide plates 32b, 32c. Thus the back face of the book block is cut while the book block is supported by the pair of guide plates 32b, 32c at the both sides thereof. After that, the book block is conveyed to the adhesive application unit C by the clamp unit 31.

The glue application unit C has a glue tank 33a filled with glue, a glue applying roller 33b, stationary and movable side glue applying rollers 33c, 33d, a motor M3 for moving the movable side glue applying roller 33d in directions toward and away from the stationary side glue applying roller 33c, and a roller 33e wiping off an excessive adhesive. When the application of glue is completed, the book block is conveyed to the cover attachment unit D by the clamp unit 31.

The cover attachment unit D includes a bottom plate 34c, stationary and movable nip plates 34a, 34b, and a motor M4 for moving the movable nip plate 34b in directions toward and away from the stationary nip plate 34a.

A cover supply unit E includes a tray on which a cover Q is placed, and a cover feed mechanism conveying the cover Q from the tray onto the bottom plate 34c and the pair of nip plates 34a, 34b of the cover attachment unit D.

The cover feed mechanism has a pair of fold line forming rollers 35a, 35b for forming fold lines at predetermined positions on the cover Q. The fold line forming rollers 35a, 35b are composed of a stationary fold line forming roller 35a and a movable fold line forming roller 35b. The movable fold line forming roller 35b is moved by a motor M5 in directions toward and away from the stationary fold line forming roller 35a.

The perfect binding machine includes a thickness measurement unit 36 for measuring a thickness of the book block. Prior to the start of the bookbinding operation of the machine, a thickness of the book block is measured by an operator through the use of the thickness measurement unit 36. Thus, a gap between the pair of clamp plates 31a, 31b, a gap between the pair of guide plates 32b, 32c of the milling unit B, a gap of the pair of side glue applying rollers 33c, 33d of the glue application unit C, a gap between the pair of nip plates 34a, 34b of the cover attachment unit D and a gap between the pair of fold line forming rollers 35a, 35b of the cover feed mechanism E are adjusted by a controller 37 based on the measurement value of the thickness of the book block.

Thus the book block is held between the pair of clamp plates 31a, 31b of the clamp unit 31 and then, while the book block is conveyed by the clamp unit 31 along the series of binding units B-D, the perfect binding is performed.

According to the glue application unit C of this perfect binding machine, prior to the start of the bookbinding operation of the machine, the gap between the pair of side glue application rollers 33c, 33d is adjusted such that the gap corresponds to the thickness of the book block to be bound. Therefore, if the back of the book block is undulated in its length direction although the book block is nipped between the pair of clamp plates 31a, 31b, the side glue application rollers 33c, 33d cannot engage with the back margins of the book block while being pushed against the back margins at a constant pressure throughout the length of the back margins during the passage of the book block over the glue application unit C, which causes a problem that the glue is unevenly applied to the back margins of the book block and the quality of the bookbinding is reduced.

Furthermore, in this glue application unit C, the gap between the pair of side glue application rollers 33c, 33d is adjusted by moving the movable side glue application roller 33d against the stationary side glue application roller 33c through the use of the motor M3, which complicates the gap adjustment mechanism, thereby raises the manufacturing cost of the glue application unit C and becomes a factor of growing the unit C in size.

### PRIOR ART DOCUMENTS

### Patent Documents

Patent Document 1: Japanese Laid-Open Patent Publication No. 2009-285906

### SUMMARY OF THE INVENTION

### Problems to be Solved by the Invention

It is an object of the present invention to assure a uniform application of the glue to the back margins located at both sides of the back face of the book block with reduction of the manufacturing cost of the glue application unit by simplifying the structure thereof.

### Means for Solving the Problems

In order to achieve this object, according to the present invention, there is provided a glue application unit built in a perfect binding machine and arranged under a path of a clamp unit of the perfect binding machine so as to apply glue on back margins located at both sides of a back face of a book block as well as the back face while the clamp unit moves through the glue application unit, both the back face and the back margins protruding downwardly from the clamp unit, the glue application unit comprising: a frame; a glue tank attached to the frame and filled with glue; a glue application roller arranged in the glue tank and attached to the frame for rotation about a shaft thereof extending across the path of the clamp unit, the glue application roller applying the glue to the back face of the book block; a motor attached to the frame and rotating the glue application roller, a part of the glue application roller being soaked in the glue of the glue tank, the glue application roller engaging with the back face of the book block at its top face covered with the glue; side glue application members attached to the frame and arranged at both sides of a path of a portion of the book block protruding downwardly from the clamp so as to engage with the back margins of the book block, the side glue application members having a pair of scrapers, each of the scrapers being composed of an elastic rod-like or elongated plate-like body and a scraping portion provided at a leading end of the body, the scrapers obliquely extending in a direction of movement of the book block from the outside of the path of the downwardly protruding portion of the book block into said path in such a way that the scrapers cross each other in an inverted V shaped configuration to close off said path, tail ends of the bodies of the scrapers being attached to the frame or the glue tank outside said path, the scraping portions of the scrapers being positioned at the downstream of the top face of the glue application roller, whereby the scraping portions engage with the back margins of the book block by the elastic biasing of the bodies while the downwardly protruding portion of the book block passes between the scrapers.

According to a preferred embodiment of the present invention, a leading end portion of the rod-like body of each of the scrapers is bent downwardly and forms the scraping portion.

According to another preferred embodiment of the present invention, the scraping portion of each of the scrapers is a hollow or solid cylinder extending vertically, and the cylinder engages with the back margin of the book block at a part of an outer periphery thereof.

According to a further preferred embodiment of the present invention, a leading end portion of the elongated plate-like body of each of the scrapers is bent along a width direction thereof, and the resulting fold line forms a corner, and the corner forms the scraping portion, and the pair of the scrapers are attached to the frame in such a manner that the corners are opposite to each other.

According to a further preferred embodiment of the present invention, the scraping portion of each of the scrapers comprises: a roller receiving portion located at the leading end of the body, the roller receiving portion having upper and lower support surfaces which are arranged opposite to each other and an opening formed between the upper and lower support surface; and a scrape roller arranged in the opening of the roller receiving portion and attached between the upper and lower support surfaces for rotation about an axis extending vertically, an outer periphery of the scrape roller engaging with the back margin of the book block.

According to a further preferred embodiment of the present invention, the body of the scraper is fixed to a height-adjustable base at tail end thereof, the base being attached to the frame or the glue tank.

According to a further preferred embodiment of the present invention, the glue application unit further comprises: a wiper attached to the frame and located upstream of the top face of the glue application roller in a direction of the rotation of the glue application roller in such a way that the wiper can come into contact with and separate from the outer periphery of the glue application roller so as to change the thickness of the glue covering the top face of the glue application roller; and a wiper drive mechanism attached to the frame so as to actuate the wiper.

### Effect of the Invention

According to the present invention, the pair of scrapers which cross each other in the inverted V shaped configuration always closes off the path of the portion of the book block downwardly protruding from the clamp unit, and during the clamp unit moves through the glue application unit, the downwardly protruding portion of the book block passes between the scrapers while pushing out the boundary of the scrapers against the elastic force of the bodies of the scrapers.

Consequently, for various book blocks of different thickness, the pair of scrapers engages certainly with the back margins of the book block, so that the uniform crosswise glue application along the length of the book block is achieved. Furthermore, even though the back of the book block is undulated along the length thereof, the scraping portions of the scrapers can follow the undulation of the back margins of the book block, and thereby the scraping portions certainly engage with the back margins of the book block during the passage of the clamp unit, so that the uniform crosswise glue application is achieved.

In addition, there is no necessity to provide a gap adjustment mechanism for the pair of scrapers because the gap between the pair of scrapers need not be adjusted according to the thickness of the book block, and thereby the structure of the glue application unit is simplified and the manufacturing cost thereof is reduced.

### BRIEF DESCRIPTION OF THE DRAWINGS

FIG. 1 is a perspective view schematically showing a structure of a glue application unit for a perfect binding machine in accordance with one embodiment of the present invention.

FIG. 2 is a side view schematically showing the glue application unit shown in FIG. 1, in which a book block moves through the unit.

FIGS. 3A-3B are plan views schematically showing the glue application unit shown in FIG. 1, in which a book block moves through the unit.

FIG. 4A-4C are perspective views of modified embodiments of a scraper.

FIG. 5A-5C are plan views showing a state in which a book block whose back is undulated along its length passes between the scrapers of the glue application unit shown in FIG. 1.

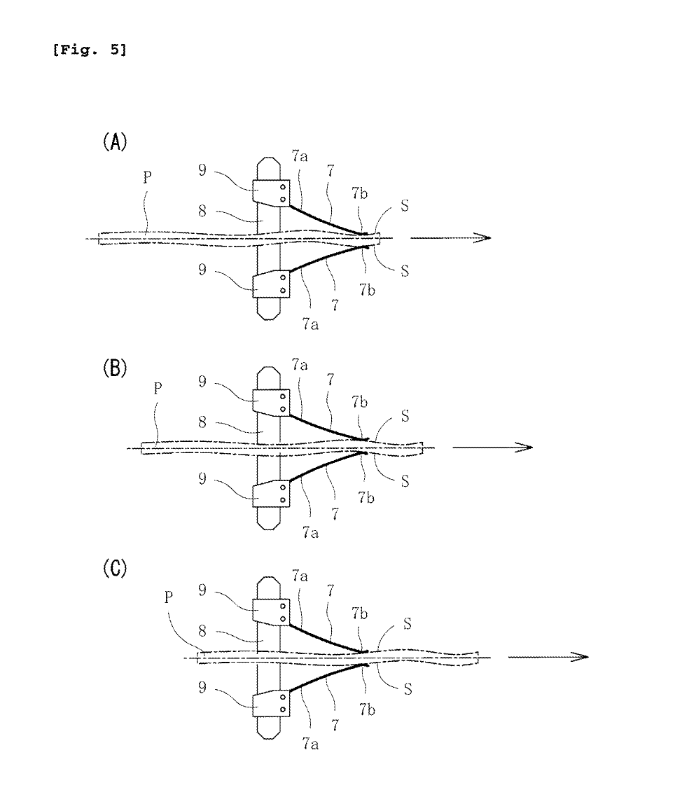

FIG. 6 is a plan view schematically showing a structure of a conventional perfect binding machine.

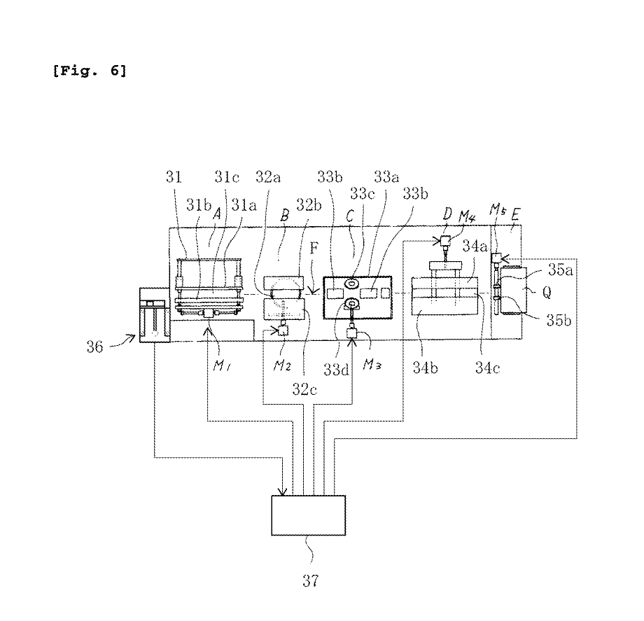

### BEST MODE FOR CARRYING OUT THE INVENTION

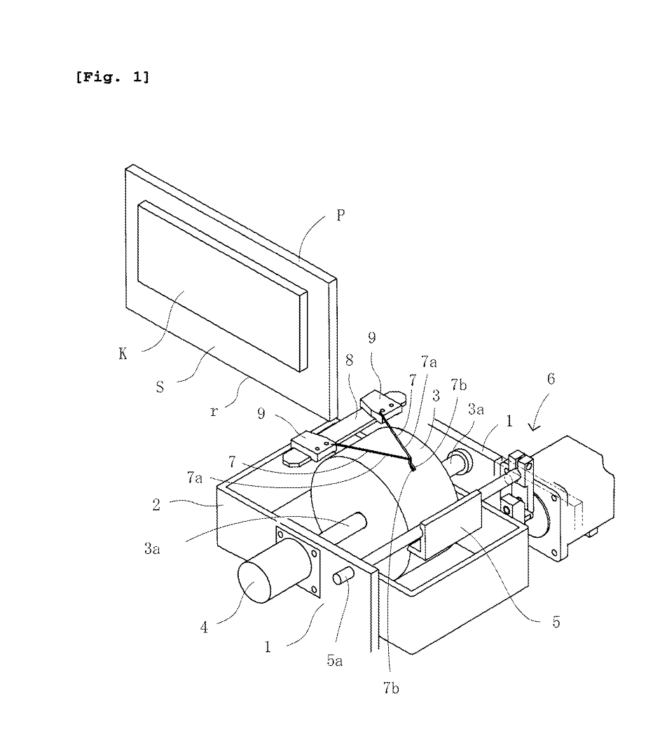

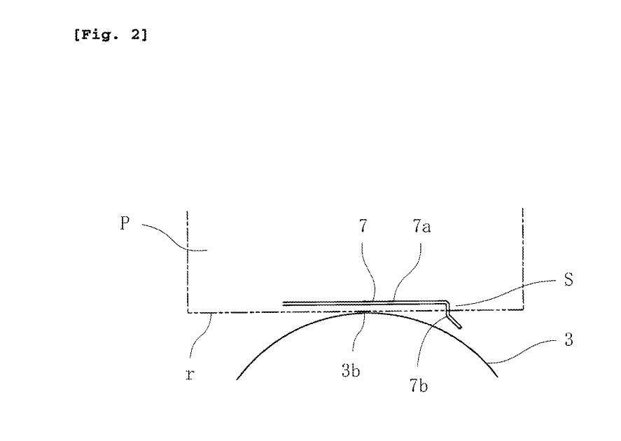

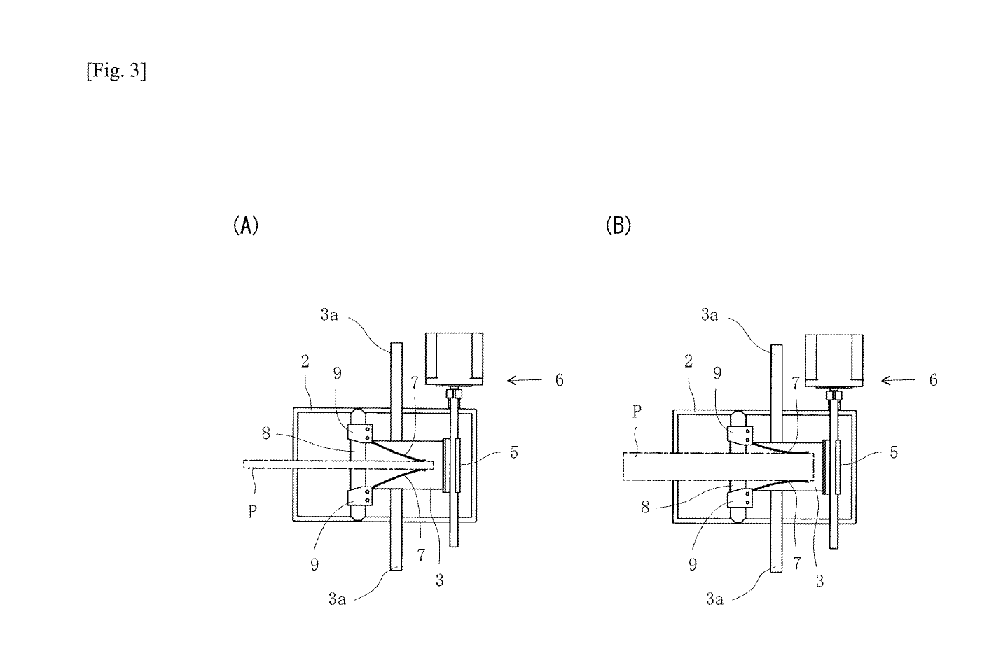

A preferred embodiment of the present invention will be described below with reference to accompanying drawings. FIG. 1 is a perspective view showing a main part of a glue application unit of a perfect binding machine according to one embodiment of the present invention, and FIG. 2 is a side view of the glue application unit shown in FIG. 1, in which a book block moves through the unit. FIGS. 3A-3C are plan views showing a main part of the glue application unit shown in FIG. 1, in which a book block moves through the unit.

The glue application unit according to the present invention is built in a perfect binding machine and arranged under a path of a clamp unit K of the perfect binding machine and applies glue on back margins s located at both sides of a back face r of the book block P as well as the back face r while the clamp unit K moves through the glue application unit.

As shown in FIGS. 1 and 2, the glue application unit of the present invention comprises a frame 1, and a glue tank 2 attached to the frame 1 and filled with glue. The glue is a kind of glue which is melted by heating such as hot-melt adhesive. The glue tank is heated by a heater (not shown) in operation of the glue application unit.

The glue application unit also comprises a glue application roller 3 arranged in the glue tank 2 and attached to the frame 1 for rotation about its shaft 3a extending across the path of the clamp unit K. The glue application roller 3 applies the glue to the back face r of the book block P. The glue application unit further comprises a motor 4 attached to the frame 1 and connected to the shaft 3a of the glue application roller 3 so as to rotate the roller 3.

A part of the glue application roller 3 is soaked in the glue of the glue tank 2 and the glue application roller 3 engages with the back face r of the book block P at its top face covered with the glue. The glue application roller 3 is rotated by the motor 4 at a constant rate in the same direction as or a direction opposite to the direction of motion of the clamp unit K. In the embodiment shown in FIG. 1, the glue application roller 3 is rotated in a direction opposite to the direction of motion of the clamp unit K.

The glue application unit also comprises a wiper 5 attached to the frame 1 and arranged upstream of the top face of the glue application roller 3 in a direction of the rotation of the glue application roller 3 in such a way that the wiper 5 can come into contact with and separate from the outer periphery of the glue application roller 3, and a wiper drive mechanism 6 attached to the frame 1 so as to actuate the wiper 5. A distance between the wiper 5 and the outer periphery of the glue application roller 3 is adjusted so as to change the thickness of the glue covering the top face of the glue application roller 3. The wiper 5 and the wiper drive mechanism 6 are provided as necessary.

The glue application unit further comprises side glue application members attached to the frame 1 and arranged at both sides of a path of a portion of the book block P so as to engage with the back margins s of the book block P. Thus, after application of the glue to the back face r of the book block P, the glue which protrudes from the both sides of the back face r is applied to the back margins s by the side glue application members.

According to the present invention, the side glue application members having a pair of scrapers 7, 7. In this embodiment, the scraper 7 is composed of an elastic rod-like body 7a and a scraping portion 7b provided at a leading end of the body 7a. The scraping portion 7b consists of the leading end portion of the body 7a which is bent downwardly at a right angle and further bent forward and obliquely downward. Although the scraping portion 7b consists of the leading end of the body 7a which is bent downwardly twice in this embodiment, it is possible to form the scraping portion 7b by downwardly bending the leading end of the body 7a at any angle and an arbitrary number of times.

As shown in FIG. 1, the scrapers 7, 7 obliquely extend in a direction of movement of the book block P from the outside of the path of the downwardly protruding portion of the book block P into such path in such a way that the scrapers 7, 7 cross each other in an inverted V shaped configuration to close off such path. Then tail ends of the bodies 7a, 7a of the scrapers 7, 7 are attached to the frame 1 or the glue tank 2 outside such path, and the scraping portions 7b, 7b of the scrapers 7, 7 are positioned at the downstream of the top face 3b of the glue application roller 3.

In this embodiment, a support plate 8 is attached to the frame 1 below the path of a portion of the book block P protruding downwardly from the clamp K and extends across the direction of movement of the book block P. Support bases 9 are arranged at both side of such path and attached to the support plate 8, and the tail ends of the bodies 7a of the associated scrapers 7 is fixed to the support bases 9. In this case, each of the support bases 9 may be height-adjustable.

According to the present invention, the pair of scrapers 7, 7 which cross each other in the inverted V shaped configuration always closes off the path of the portion of the book block P downwardly protruding from the clamp unit K, and during the clamp unit K passes the glue application unit, the downwardly protruding portion of the book block P passes between the scrapers 7, 7 while pushing out the boundary of the scrapers 7, 7 against the elastic force of the bodies 7a, 7a of the scrapers 7, 7.

Thus, as shown in FIGS. 3A and 3B, for various book blocks of different thickness, the pair of scrapers 7, 7 engages certainly with the back margins s of the book block P. Consequently, the glue which protrudes from both sides of the back face r of the book block P after application of the glue to the back face r is applied uniformly to the back margins s of the book block P while being wiped by the scrapers 7, 7. Furthermore, even though the back of the book block P is undulated along the length thereof, the scraping portions 7b, 7b of the scrapers 7, 7 can follow the undulation of the back margins s of the book block P, and thereby the scraping portions 7b, 7b certainly engage with the back margins s during the passage of the clamp unit K, so that the uniform crosswise glue application is achieved.

Furthermore, there is no necessity to provide a gap adjustment mechanism for the pair of scrapers 7, 7 because the gap between the pair of scrapers 7, 7 need not be adjusted according to the thickness of the book block, so that the structure of the glue application unit is simplified and the manufacturing cost thereof is reduced.

Although the present invention has been explained based on one preferred embodiment thereof, the structural features of the present invention are not limited to this embodiment. One skilled in the art can easily devise various modified embodiments within the scope of the claims of the present application.

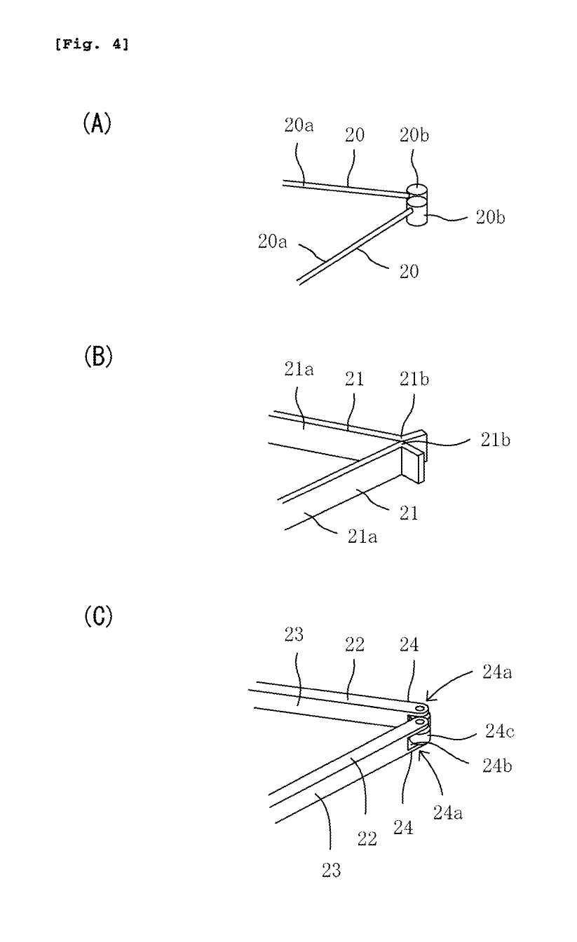

For example, according to a further preferred embodiment of the present invention, as shown in FIG. 4A, the body 20a of each of the scrapers 20 is an elastic rod, and the scraping portion 20b is a hollow or solid cylinder provided at a leading end of the body 20a and extending vertically. The scraping portion (cylinder) 20b engages with the back margin s of the book block P at a part of an outer periphery thereof.

According to a further embodiment of the present invention, as shown in FIG. 4B, each of the scrapers 21, 21 comprises an elongated elastic plate-like body 21a. A leading end of the body 21a is bent along a width direction thereof and the resulting fold line forms a corner 21b. The corner 21b forms the scraping portion. Thus the pair of the scrapers 21, 21 are attached to the frame 1 in such a manner that the scraping portions (corners) 21b, 21b are opposite to each other.

According to a further embodiment of the present invention, as shown in FIG. 4C, the body 23 of each of the scrapers 22 is an elongated elastic plate, and the scraping portion 24 comprises a roller receiving portion 24a located at the leading end of the body 23. The roller receiving portion 24a has upper and lower support surfaces which are arranged opposite to each other and an opening 24b formed between the upper and lower support surface. The scraping portion 24 further comprises a scrape roller 24c arranged in the opening 24b of the roller receiving portion 24a and attached between the upper and lower support surfaces for rotation about an axis extending vertically. An outer periphery of the scrape roller 24c engages with the back margin s of the book block P.

### DESCRIPTION OF REFERENCE SIGNS

1 Frame
2 Glue tank
3 Glue application roller
3a Shaft
3b Top face
4 Motor
5 Wiper
5a Axis
6 Wiper drive mechanism
7 Scraper
7a Body
7b Scraping portion
8 Support plate
9 Support base
20 Scraper
20a Body
20b Scraping portion (Cylinder)
21 Scraper
21a Body
21b Scraping portion (Corner)
22 Scraper
23 Body
24 Scraping portion
24a Roller receiving portion
24b Opening
24c Scraping roller
K Clamp unit
P Book block
r Back face
s Back margin

1. A glue application unit built in a perfect binding machine and arranged under a path of a clamp unit of the perfect binding machine so as to apply glue on back margins located at both sides of a back face of a book block as well as the back face while the clamp unit passes through the glue application unit, both the back face and the back margins protruding downwardly from the clamp unit, the glue application unit comprising:
a frame;
a glue tank attached to the frame and filled with glue;
a glue application roller arranged in the glue tank and attached to the frame for rotation about a shaft thereof extending across the path of the clamp unit, the glue application roller applying the glue to the back face of the book block;
a motor attached to the frame and rotating the glue application roller, a part of the glue application roller being soaked in the glue of the glue tank, the glue application roller engaging with the back face of the book block at its top face covered with the glue;
side glue application members attached to the frame and arranged at both sides of a path of a portion of the book block protruding downwardly from the clamp so as to engage with the back margins of the book block, the side glue application members having a pair of scrapers,
each of the scrapers being composed of an elastic rod-like or elongated plate-like body and a scraping portion provided at a leading end of the body,
the scrapers obliquely extending in a direction of movement of the book block from the outside of the path of the downwardly protruding portion of the book block into said path in such a way that the scrapers cross each other in an inverted V shaped configuration to close off said path, tail ends of the bodies of the scrapers being attached to the frame or the glue tank outside said path, the scraping portions of the scrapers being positioned at the downstream of the top face of the glue application roller,
whereby the scraping portions engage with the back margins of the book block by the elastic biasing of the bodies while the downwardly protruding portion of the book block passes between the scrapers.

2. The glue application unit according to claim 1, wherein a leading end portion of the rod-like body of each of the scrapers is bent downwardly and forms the scraping portion.

3. The glue application unit according to claim 1, wherein the scraping portion of each of the scrapers is a hollow or solid cylinder extending vertically, and the cylinder engages with the back margin of the book block at a part of an outer periphery thereof.

4. The glue application unit according to claim 1, wherein a leading end portion of the elongated plate-like body of each of the scrapers is bent along a width direction thereof, and the resulting fold line forms a corner, and the corner forms the scraping portion, and the pair of the scrapers are attached to the frame in such a manner that the corners are opposite to each other.

5. The glue application unit according to claim 1, wherein the scraping portion of each of the scrapers comprises:
a roller receiving portion located at the leading end of the body, the roller receiving portion having upper and lower support surfaces which are arranged opposite to each other and an opening formed between the upper and lower support surface; and
a scrape roller arranged in the opening of the roller receiving portion and attached between the upper and lower support surfaces for rotation about an axis extending vertically, an outer periphery of the scrape roller engaging with the back margin of the book block.

6. The glue application unit according to claim 1, wherein the body of the scraper is fixed to a height-adjustable base at tail end thereof, base being attached to the frame or the glue tank.

7. The glue application unit according to claim 1, further comprising:
a wiper attached to the frame and located upstream of the top face of the glue application roller in a direction of the rotation of the glue application roller in such a way that the wiper can come into contact with and separate from the outer periphery of the glue application roller so as to change the thickness of the glue covering the top face of the glue application roller; and
a wiper drive mechanism attached to the frame so as to actuate the wiper.
